(19) United States
(12) Patent Application Publication
(10) Pub. No.: US 2025/0155007 A1
(43) Pub. Date: May 15, 2025

(54) Gearing for An Electrical Drive System of a Motor Vehicle, and Electrical Drive System Having a Gearing of this Kind

(71) Applicant: ZF Friedrichshafen AG, Friedrichshafen (DE)

(72) Inventors: Martin Brehmer, Tettnang (DE); Christopher Allnoch, Kressbronn (DE)

(21) Appl. No.: 18/840,687

(22) PCT Filed: Jan. 23, 2023
(86) PCT No.: PCT/EP2023/051466

§ 371 Date: Aug. 22, 2024

(30) Foreign Application Priority Data
Feb. 22, 2022 (DE) 10 2022 201 820.6

(51) Int. Cl. F16H 37/08

(52) U.S. Cl. CPC F16H 37/082; F16H 2200/0021; F16H 2200/0034; F16H 2200/2007; F16H 2200/2035

(57) ABSTRACT

A transmission (G) for an electric propulsion system of a motor vehicle includes at least one first planetary gear set (P1), a differential (D) operatively connected to the at least one first planetary gear set (P1), and a first output shaft (AB1) and a second output shaft (AB2) operatively connected to the differential (D). A first element (E11) of the first planetary gear set (P1) is configured to conduct a drive power from an electric machine (EM) into the first planetary gear set (P1). A second element (E21) of the first planetary gear set (P1) is configured to conduct the drive power of the electric machine (EM) out of the first planetary gear set (P1). A third element (E31) of the first planetary gear set (P1) is connected to a rotationally fixed component of the transmission (G) for conjoint rotation.

### CROSS-REFERENCE TO RELATED APPLICATIONS

The present application is related and has right of priority to German Patent Application No. DE 102022201820.6 filed on Feb. 22, 2022, and is a U.S. national phase of PCT/EP2023/051466 filed on Jan. 23, 2023, both of which are incorporated by reference in their entireties for all purposes.

### TECHNICAL FIELD

The invention relates generally to a transmission for an electric propulsion system of a motor vehicle, which transmission has at least one first planetary gear set, a differential, and a first output shaft and a second output shaft. The invention further relates generally to an electric propulsion system for a motor vehicle, which has a transmission and an electric machine, the electric machine including a stator and a rotor.

### BACKGROUND

WO 2015/082168 A1 discloses a transmission having a transmission input shaft and a transmission output shaft, a main gear set, an additional gear set, and an electric machine which includes a rotor and a stator. The transmission has at least one power path between the transmission input shaft and the main gear set, the main gear set having a first and a second planetary gear set with a total of four shafts described as the first, the second, the third, and the fourth shaft in order of rotational speed. The at least one power path is connectable to at least one of the four shafts of the main gear set by at least one shift element. The third shaft of the main gear set is connected to the transmission output shaft. The additional gear set has a planetary gear set having a first, a second, and a third shaft, the first shaft of the additional gear set being permanently connected to the rotor. The first planetary gear set of the main gear set is in the form of a positive gear set and the second planetary gear set of the main gear set is in the form of a negative gear set. A planet carrier of the first planetary gear set of the main gear set, a planet carrier of the second planetary gear set of the main gear set, and a planet carrier of the planetary gear set of the additional gear set are connected to each other. Furthermore, a ring gear of the planetary gear set of the additional gear set and a ring gear of the first planetary gear set of the main gear set are connected to each other. A sun gear of the planetary gear set of the additional gear set meshes with outer planet gears of the first planetary gear set of the main gear set.

### BRIEF SUMMARY

Example aspects of the invention provide an alternative transmission for an electric propulsion system of a motor vehicle. Furthermore, an electric propulsion system for a motor vehicle is to be provided.

A transmission according to example aspects of the invention for an electric propulsion system of a motor vehicle has at least one first planetary gear set, a differential which is operatively connected to the at least one first planetary gear set, and a first and a second output shaft which are operatively connected to the differential. The first planetary gear set has a first, a second, and a third element, the first element of the first planetary gear set being configured to conduct a drive power from a first electric machine into the first planetary gear set, and the second element of the first planetary gear set is configured to conduct the drive power of the electric machine out of the first planetary gear set. The third element of the first planetary gear set is connected to a rotationally fixed component of the transmission for conjoint rotation.

The elements of the first planetary gear set are in the form, in particular, of a sun gear, a planet carrier, and a ring gear. If an element is rotationally fixed, i.e., connected to a rotationally fixed component of the transmission for conjoint rotation, the element is prevented from making a rotational motion. The rotationally fixed component of the transmission can preferably be a permanently non-rotating component, preferably a housing of the transmission, a portion of such a housing, or an element which is connected thereto for conjoint rotation.

An operative connection between the differential and the at least one first planetary gear set is to be understood to mean that the differential is either directly connected to the first planetary gear set or is connected to the first planetary gear set at least indirectly via multiple shafts, in particular via further planetary gear sets. Therefore, at least one further planetary gear set can be arranged in the power flow between the differential and the at least one first planetary gear set. Furthermore, an operative connection between the first and the second output shafts to the differential is to be understood to mean that the particular output shaft is either directly connected to, or is meshed with, a shaft or an element of the differential, or at least one further shaft or one further element is arranged between the particular output shaft and the shaft or the element of the differential. The particular output shaft is preferably operatively connected to a wheel of a drive axle of the motor vehicle.

As set forth in the invention, a “shaft” is understood to be a rotatable component of the transmission, via which associated components of the transmission are connected to one another for conjoint rotation or via which a connection of this type is established when an appropriate shift element is actuated. The shaft can be in the form, for example, of a gear wheel, a ring gear, a sun gear, or a planet carrier.

In particular, the first planetary gear set is in the form of a negative planetary gear set. A negative planetary gear set is composed of the elements sun gear, planet carrier, and ring gear, wherein the planet carrier guides at least one, preferably however, multiple rotatably mounted planet gear(s), each of which meshes with the sun gear as well as with the surrounding ring gear. When gear wheels mesh with one another, the gear wheels are engaged with one another.

Conducting a drive power of the electric machine into the first planetary gear set via the first element of the first planetary gear set means that the first element of the first planetary gear set is configured to drive the first planetary gear set. For example, the first element of the first planetary gear set is in the form of a sun gear.

Conducting a drive power of the electric machine out of the first planetary gear set via the second element of the first planetary gear set means that the second element of the first planetary gear set is configured as the output of the first planetary gear set. For example, the second element of the first planetary gear set is in the form of a planet carrier.

The electric machine is in the form of an electric motor and includes a stator and a rotor. Via the rotor and a rotor shaft, which is connected thereto for conjoint rotation, the drive power is generated and conducted into the transmission, or into the rotatable transmission components. In particular, the electric machine is part of the transmission and is arranged together with the at least first planetary gear set and the differential in a common housing.

Preferably, at least one second planetary gear set is arranged in the power flow between the first planetary gear set and the differential, the second planetary gear set having a first, a second, and a third element. The elements of the second planetary gear set are in the form, in particular, of a sun gear, a planet carrier, and a ring gear. An arrangement of a second planetary gear set in the power flow between the first planetary gear set and the differential is to be understood to mean that the second planetary gear set is connected in terms of input to the first planetary gear set on the input side and is connected in terms of output to the differential on the output side. In particular, the second planetary gear set is in the form of a negative planetary gear set.

According to one preferred example embodiment, the first element of the second planetary gear set is connected to the second element of the first planetary gear set for conjoint rotation in order to conduct the drive power of the electric machine into the second planetary gear set. The second element of the second planetary gear set is configured to conduct the drive power of the electric machine out of the second planetary gear set, and the third element of the second planetary gear set is connected to a rotationally fixed component of the transmission for conjoint rotation.

According to one further preferred example embodiment, the first element of the second planetary gear set is connected to a rotationally fixed component of the transmission for conjoint rotation. The second element of the second planetary gear set is configured to conduct the drive power of the electric machine out of the second planetary gear set, and the third element of the second planetary gear set is connected to the second element of the first planetary gear set for conjoint rotation in order to conduct the drive power of the electric machine into the second planetary gear set.

For example, the differential is in the form of a spur gear differential, which spur gear differential has a first, a second, and a third element. The spur gear differential is in the form of a positive planetary gear set and includes the elements sun gear, ring gear, and planet carrier. The planet carrier guides at least one planet gear pair in which one planet gear meshes with the internal sun gear and the other planet gear meshes with the surrounding ring gear, and the planet gears are meshed with each other.

Preferably, the first element of the spur gear differential is connected to the first output shaft for conjoint rotation, the second element of the spur gear differential being configured to conduct a drive power of the electric machine into the spur gear differential, and the third element of the spur gear differential is connected to the second output shaft for conjoint rotation. Therefore, an output of the transmission takes place via the first and the third elements of the spur gear differential, i.e., via the sun gear and the planet carrier of the spur gear differential. The input of the spur gear differential therefore takes place via the second element of the spur gear differential, which is in the form of a ring gear.

According to an alternative exemplary embodiment, the differential is in the form of a ball differential and includes a differential cage and multiple differential bevel gears. Via the spherical differential cage, the drive power of the electric machine is conducted into the differential, the differential bevel gears being meshed in a known way with respective teeth on the particular output axle in order to distribute the drive power onto the two output shafts.

According to a preferred exemplary embodiment, at least the first and the second planetary gear sets are arranged axially in series. Therefore, the first and the second planetary gear sets are arranged axially next to each other. As a result, the transmission becomes more radially compact. In particular, the differential is also arranged axially in series with the first and the second planetary gear sets.

According to an alternative exemplary embodiment, at least the first and the second planetary gear sets are radially stacked. Therefore, the first and the second planetary gear sets are arranged radially above each other. As a result, the transmission becomes more axially compact. In particular, the differential is axially adjacent to the first planetary gear set.

Preferably, a front-mounted planetary gear set is arranged in the power flow upstream of the first planetary gear set, the front-mounted planetary gear set having a first, a second, and a third element. The elements of the first front-mounted planetary gear set are in the form, in particular, of a sun gear, a planet carrier, and a ring gear. In particular, the first planetary gear set is in the form of a negative planetary gear set.

Preferably, the first element of the front-mounted planetary gear set is connectable to a rotationally fixed component of the transmission for conjoint rotation via a first shift element. Two of the three elements of the front-mounted planetary gear set are connectable to each other for conjoint rotation via a second shift element in order to interlock the front-mounted planetary gear set. When the front-mounted planetary gear set is interlocked, the transmission ratio is always one (1) regardless of the number of teeth of the elements of the front-mounted planetary gear set. In other words, the front-mounted planetary gear set rotates as a unit, and all three elements of the front-mounted planetary gear set rotate at the same rotational speed.

For example, the first element of the front-mounted planetary gear set is connectable to the third element of the front-mounted planetary gear set for conjoint rotation via the second shift element. In particular, the second shift element is then arranged and designed such that, when actuated, the second shift element connects the first element to the third element of the front-mounted planetary gear set.

Alternatively, the second element of the front-mounted planetary gear set is connectable to the first element of the front-mounted planetary gear set for conjoint rotation via the second shift element. In particular, the second shift element is then arranged and designed such that, when actuated, the second shift element connects the second element to the first element of the front-mounted planetary gear set.

Further alternatively, the third element of the front-mounted planetary gear set is connectable to the second element of the front-mounted planetary gear set for conjoint rotation via the second shift element. In particular, the second shift element is then arranged and designed such that, when actuated, the second shift element connects the third element to the second element of the front-mounted planetary gear set.

A shift element is to be understood as a device which has at least one disengaged state and one engaged state, wherein the device in the disengaged state cannot transmit torque between two elements interacting with this device, or the shift element, and wherein the device in the engaged state can transmit a torque between two elements interacting with this device, or the shift element. A connection between two elements is provided to transmit torques and forces, or a rotational motion, from one transmission element onto the other transmission element.

Further preferably, the first and the second shift element are configured to implement a first and a second gear step. When the first shift element is engaged and the second shift element is disengaged, the first gear step is implemented. When the first shift element is disengaged and the second shift element is engaged, the second gear step is implemented. Therefore, when the first shift element is engaged, the first element of the front-mounted planetary gear set is fixed in a stationary manner on the rotationally fixed component of the transmission, in particular being braked on the housing. The first shift element is in the form of a brake. By comparison, when the second shift element is engaged, the first element of the front-mounted planetary gear set is connected to the third element of the front-mounted planetary gear set for conjoint rotation. When the second shift element is disengaged, the first element of the front-mounted planetary gear set and the third element of the front-mounted planetary gear set can rotate relative to each other. Therefore, the second shift element is in the form of a clutch.

In particular, the third element of the front-mounted planetary gear set is configured such that, in the first gear step, the third element conducts the drive power of the electric machine into the front-mounted planetary gear set. The first and the third elements of the front-mounted planetary gear set are configured such that, in the second gear step, the first and the third elements conduct the drive power of the electric machine into the front-mounted planetary gear set. Therefore, in the first gear step, the drive power of the electric machine is introduced via the third element of the front-mounted planetary gear set, the first element of the front-mounted planetary gear set being supported on the rotationally fixed component of the transmission. By comparison, in the second gear step, the drive power of the electric machine is introduced via the first and the third elements of the front-mounted planetary gear set, and therefore the front-mounted planetary gear set is interlocked, or rotates as a unit.

For example, at least the front-mounted planetary gear set, the two shift elements, the first planetary gear set, and the differential are arranged in a common housing, the electric machine being configured to be arranged at least axially between the front-mounted planetary gear set and the first planetary gear set. In particular, the electric machine is integrated in the housing such that the transmission, together with the electric machine, forms the propulsion system of the motor vehicle. The stator of the electric machine is arranged on the common housing in a rotationally fixed manner, the front-mounted planetary gear set being arranged with the two shift elements on a first end face of the electric machine, and at least the first planetary gear set and the differential are arranged on a second end face of the electric machine. Therefore, the motor vehicle is in the form of an electric vehicle and includes the transmission according to example aspects of the invention and the electric machine, which together form the electric propulsion system.

Preferably, the two shift elements are arranged within a first axial end portion of the common housing, the differential being arranged within a second axial end portion of the common housing. Therefore, the two shift elements have a maximum distance to the differential.

### BRIEF DESCRIPTION OF THE DRAWINGS

Multiple exemplary embodiments of the invention are explained in greater detail in the following with reference to the drawings. Wherein:

FIG. 1 shows a highly simplified diagram of a first electric propulsion system of a motor vehicle, which is shown only in part;

FIG. 2 shows a highly simplified diagram of a second electric propulsion system of a motor vehicle, which is shown only in part;

FIG. 3 shows a highly simplified diagram of a third electric propulsion system of a motor vehicle, which is shown only in part;

FIG. 4 shows a highly simplified diagram of a fourth electric propulsion system of a motor vehicle, which is shown only in part;

FIG. 5 shows a highly simplified diagram of a fifth electric propulsion system of a motor vehicle, which is shown only in part;

FIG. 6 shows a highly simplified diagram of a front-mounted planetary gear set for a propulsion system of a motor vehicle; and

FIG. 7 shows a highly simplified diagram of a further front-mounted planetary gear set for a propulsion system of a motor vehicle.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

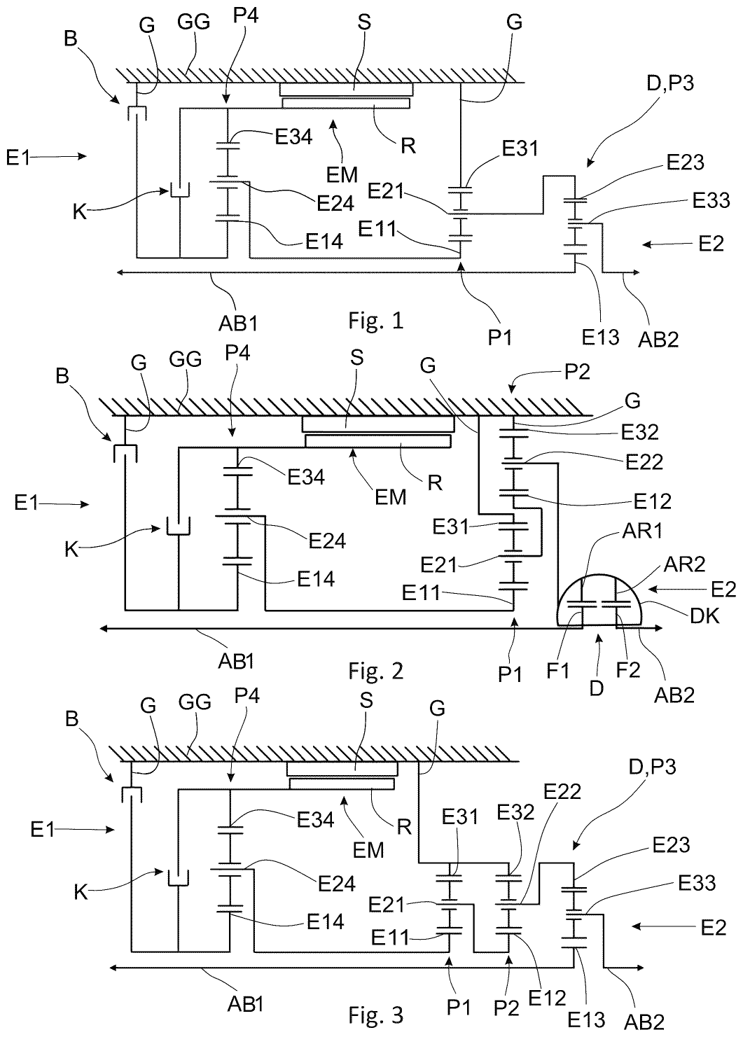

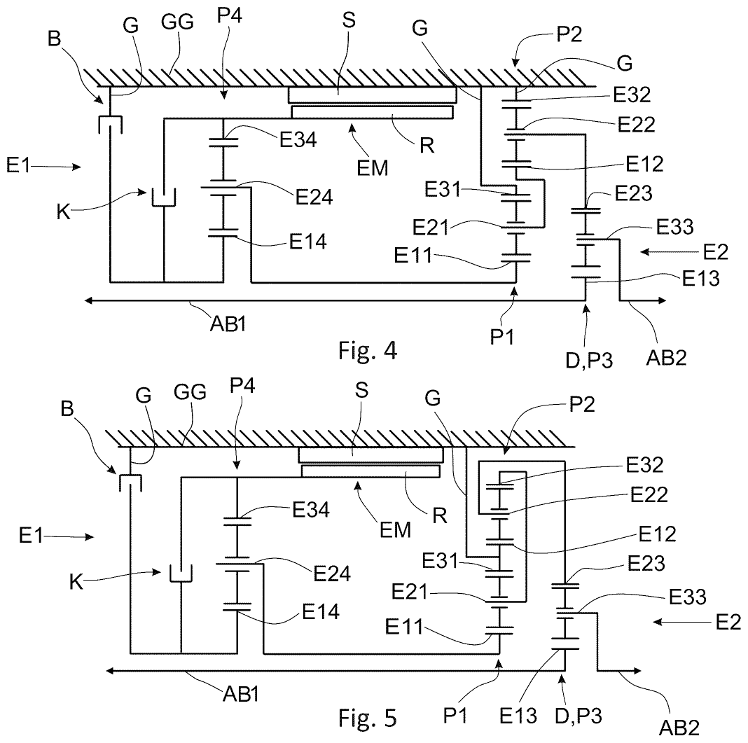

According to FIG. 1, FIG. 3, FIG. 3, FIG. 4 and FIG. 5, an electric propulsion system of a motor vehicle according to example aspects of the invention has a transmission G and an electric machine EM having a stator S and a rotor R which are arranged in a common housing GG. The transmission G has a first planetary gear set P1, a differential D which is operatively connected to the first planetary gear set P1, and a first and a second output shaft AB1, AB2 which are operatively connected to the differential D. The two output shafts AB1, AB2 are coaxial with the first planetary gear set P1, the first output shaft AB1 extending axially through the entire housing G.

The first planetary gear set P1 is in the form of a negative planetary gear set and has a first, a second, and a third element E11, E21, E31. The first element E11 of the first planetary gear set P1 is in the form of a sun gear and is configured to conduct a drive power of the electric machine EM into the first planetary gear set P1. The second element E21 of the first planetary gear set P1 is in the form of a planet carrier and is configured to conduct the drive power of the electric machine EM out of the first planetary gear P1 and thus is provided for output. The third element E31 of the first planetary gear set P1 is in the form of a ring gear and is connected to a rotationally fixed component of the transmission G for conjoint rotation. Multiple planet gears, each of which meshes with the sun gear as well as with the surrounding ring gear, are rotatably mounted on the planet carrier. The rotationally fixed component is integrally formed with the housing GG of the transmission G and, therefore, is part of the housing GG.

A front-mounted planetary gear set P4 is arranged in the power flow upstream of the first planetary gear set P1, the front-mounted planetary gear set P4 being in the form of a negative planetary gear set and having a first, a second, and a third element E14, E24, E34. The electric machine EM is arranged axially between the front-mounted planetary gear set P4 and the first planetary gear set P1. The first element E14 of the front-mounted planetary gear set P4 is in the form of a sun gear and is connectable to a rotationally fixed component of the transmission G for conjoint rotation via a first shift element B. Furthermore, the first element E14 of the front-mounted planetary gear set P4 is connectable to the third element E34 of the front-mounted planetary gear set P4 for conjoint rotation via a second shift element K. The third element E34 of the front-mounted planetary gear set P4 is in the form of a ring gear. The second element E24 of the front-mounted planetary gear set P4 is in the form of a planet carrier and is configured to conduct the drive power from the electric machine EM out of the front-mounted planetary gear set P4 and thus is provided for output. Multiple planet gears, each of which meshes with the sun gear as well as with the surrounding ring gear, are rotatably mounted on the planet carrier.

The first and the second shift elements B, K are configured to implement a first and a second gear step. When the first shift element B, which is in the form of a brake, is engaged, and the second shift element K, which is in the form of a clutch, is disengaged, the first gear step is implemented. When the first shift element B is disengaged and the second shift element K is engaged, the second gear step is implemented. The third element E34 of the front-mounted planetary gear set P4 is configured such that, in the first gear step, the third element E34 conducts the drive power from the electric machine EM into the front-mounted planetary gear set P4, the first element E14 of the front-planetary gear set P4 being rotationally fixed to the housing GG via the first shift element B. By comparison, in the second gear step, the first and the third elements E14, E13 of the front-mounted planetary gear set P4 are connected to each other for conjoint rotation and are configured to rotate as a unit, such that the drive power from the electric machine EM is conducted into the front-mounted planetary gear set P4. The two shift elements B, K are arranged within a first axial end portion E1 of the common housing GG and the differential D is arranged within a second axial end portion E2 of the common housing GG.

If two transmission stages are not required, the transmission G can be made more compact and lightweight by omitting the front-mounted planetary gear set P4 and the two shift elements B, K. The rotor R can then be connected, for example, directly, to the first element E11 of the first planetary gear set P1 for conjoint rotation. Due to the omission of the two shift elements B, K, the transmission G is no longer shiftable-only the second gear step being implemented-but the drag losses are eliminated due to the direct drive of the front-mounted planetary gear set P4 in the second gear step.

According to FIG. 2, FIG. 3, FIG. 4 and FIG. 5, a second planetary gear set P2 is arranged in the power flow between the first planetary gear set P1 and the differential D, the second planetary gear set P2 being in the form of a negative planetary gear set and having a first, a second, and a third element E12, E22, E32. The first element E12 of the second planetary gear set P2 is in the form of a sun gear. The third element E32 of the second planetary gear set P2 is in the form of a ring gear. The second element E22 of the second planetary gear set P2 is in the form of a planet carrier. Multiple planet gears, each of which meshes with the sun gear as well as with the surrounding ring gear, are rotatably mounted on the planet carrier.

According to FIG. 2, FIG. 4 and FIG. 5, the first and the second planetary gear sets P1, P2 are radially stacked, i.e., arranged one above the other in the radial direction, and thus are axially compact. According to FIG. 3, the first and the second planetary gear sets P1, P2 are arranged axially in series, i.e., next to one another in the axial direction, and thus are radially compact. The differential D is always arranged axially in series with the first planetary gear set P1.

According to FIG. 2, FIG. 3 and FIG. 4, the first element E12 of the second planetary gear set P2 is connected to the second element E21 of the first planetary gear set P1 for conjoint rotation in order to conduct the drive power of the electric machine EM from the first planetary gear set P1 into the second planetary gear set P2. The second element E22 of the second planetary gear set P2 is configured to conduct the drive power of the electric machine EM out of the second planetary gear P2 and thus is provided for output. The third element E32 of the second planetary gear set P2 is connected to a rotationally fixed component of the transmission G for conjoint rotation, the component being integrally formed with the housing GG of the transmission G.

According to FIG. 5, the first element E12 of the second planetary gear set P2 is connected to a rotationally fixed component of the transmission G for conjoint rotation, the component being integrally formed with the housing GG of the transmission G. The second element E22 of the second planetary gear set P2 is configured to conduct the drive power of the electric machine EM out of the second planetary gear P2 and thus is provided for output. The third element E32 of the second planetary gear set P2 is connected to the second element E21 of the first planetary gear set P1 for conjoint rotation in order to conduct the drive power of the electric machine EM from the first planetary gear set P1 into the second planetary gear set P2.

According to FIG. 1, FIG. 3, FIG. 4 and FIG. 5, the differential D is in the form of a spur gear differential P3. The spur gear differential P3 is in the form of a positive planetary gear set and has a first, a second, and a third element E13, E23, E33. The first element E13 of the spur gear differential P3 is in the form of a sun gear and is connected to the first output shaft AB1 for conjoint rotation. The second element E23 of the spur gear differential P3 is in the form of a ring gear and is configured to conduct a drive power from the electric machine EM into the spur gear differential P3. The third element E33 of the spur gear differential P3 is in the form of a planet carrier and is connected to the second output shaft AB2 for conjoint rotation. The planet carrier guides multiple planet gear pairs, in which one planet gear is meshed with the internal sun gear and the other planet gear is meshed with the surrounding ring gear, and the planet gears are meshed with each other in order to implement the differential function in a known way. The spur gear differential P3 is shown highly simplified in the present case.

According to FIG. 2, the differential D is in the form of a ball differential and includes a spherical differential cage DK and multiple differential bevel gears AR1, AR2 which are rotatably mounted on the spherical differential cage DK. The spherical differential cage DK is connected to the second element E22 of the second planetary gear set P2 for conjoint rotation and is configured to conduct the drive power of the electric machine EM into the ball differential. The differential bevel gears AR1, AR2 are provided for output and mesh with a fixed gear F1, F2, respectively, or with the toothing section on the output shaft AB1, AB2, respectively, in order to implement the differential function in a known way. The ball differential is shown highly simplified in the present case.

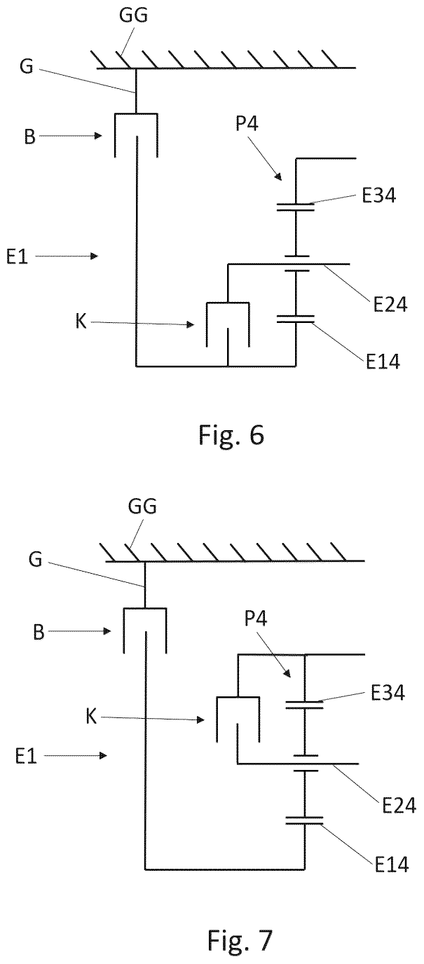

FIG. 6 and FIG. 7 each show a highly simplified diagram of a front-mounted planetary gear set P4 for a propulsion system according to example aspects of the invention. According to FIG. 1 through FIG. 5, a first example embodiment of the front-mounted planetary gear set P4 is shown the particular propulsion system according to example aspects of the invention. FIG. 6 shows, in isolation, a second example embodiment of the front-mounted planetary gear set P4 for the propulsion system according to example aspects of the invention and FIG. 7 shows, in isolation, a third example embodiment of the front-mounted planetary gear set P4 for the propulsion system according to example aspects of the invention. According to FIG. 1 through FIG. 7, two of the three elements E14, E24, E34 of the front-mounted planetary gear set P4 are connectable to each other for conjoint rotation via the second shift element K in order to interlock the front-mounted planetary gear set P4, so that the front-mounted planetary gear set P4rotates as a unit. According to FIG. 1 through FIG. 5, the first element E14 of the front-mounted planetary gear set P4 is connectable to the third element E34 of the front-mounted planetary gear set P4 for conjoint rotation via the second shift element K. In FIG. 6, the second element E24 of the front-mounted planetary gear set P4 is connectable to the first element E14 of the front-mounted planetary gear set P4 for conjoint rotation via the second shift element K. In FIG. 7, the third element E34 of the front-mounted planetary gear set P4 is connectable to the second element E24 of the front-mounted planetary gear set P4 for conjoint rotation via the second shift element K.

The front-mounted planetary gear set P4 shown in FIG. 6 and FIG. 7, respectively, is arranged in the power flow upstream of the first planetary gear set P1 and is in the form of a negative planetary gear set. The first element E14 of the front-mounted planetary gear set P4 is in the form of a sun gear and is connectable to a rotationally fixed component of the transmission G for conjoint rotation via the first shift element B, the transmission G being fixed to the housing GG. The third element E34 of the front-mounted planetary gear set P4 is in the form of a ring gear and is configured to conduct the drive power from the electric machine EM (not shown here) into the front-mounted planetary gear set P4 and thus is provided for input. The second element E24 of the front-mounted planetary gear set P4 is in the form of a planet carrier and is configured to conduct the drive power from the electric machine EM out of the front-mounted planetary gear set P4 and thus is provided for output. Multiple planet gears, each of which meshes with the sun gear as well as with the surrounding ring gear, are rotatably mounted on the planet carrier.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

EM electric machine
S stator
R rotor
B first shift element
K second shift element
P1 first planetary gear set
P2 second planetary gear set
P3 spur gear differential
P4 front-mounted planetary gear set
D differential
E11 first element of the first planetary gear set
E21 second element of the first planetary gear set
E31 third element of the first planetary gear set
E12 first element of the second planetary gear set
E22 second element of the second planetary gear set
E32 third element of the second planetary gear set
E13 first element of the spur gear differential
E23 second element of the spur gear differential
E33 third element of the spur gear differential
E14 first element of the front-mounted planetary gear set
E24 second element of the front-mounted planetary gear set
E34 third element of the front-mounted planetary gear set
AB1 first output shaft
AB2 second output shaft
G transmission
GG housing
E1 first end portion
E2 second end portion
AR1 first differential bevel gear
AR2 second differential bevel gear
F1 first fixed gear
F2 second fixed gear

1-15. (canceled)

16. 1. A transmission (G) for an electric propulsion system of a motor vehicle, comprising:
a first planetary gear set (P1) comprising a first element (E11), a second element (E21), and a third element (E31);
a differential (D) operatively connected to the first planetary gear set (P1); and
a first output shaft (AB1) and a second output shaft (AB2) operatively connected to the differential (D),
wherein the first element (E11) of the first planetary gear set (P1) is configured to conduct a drive power from an electric machine (EM) into the first planetary gear set (P1), the second element (E21) of the first planetary gear set (P1) is configured to conduct the drive power of the electric machine (EM) out of the first planetary gear set (P1), and the third element (E31) of the first planetary gear set (P1) is connected to a rotationally fixed component of the transmission (G) for conjoint rotation.

17. The transmission (G) of claim 16, further comprising a second planetary gear set (P2) arranged in power flow between the first planetary gear set (P1) and the differential (D), wherein the second planetary gear set (P2) comprises a first element (E12), a second element (E22), and a third element (E32).

18. The transmission (G) of claim 17, wherein the first element (E12) of the second planetary gear set (P2) is connected to the second element (E21) of the first planetary gear set (P1) for conjoint rotation in order to conduct the drive power of the electric machine (EM) into the second planetary gear set (P2), the second element (E22) of the second planetary gear set (P2) is configured to conduct the drive power of the electric machine (EM) out of the second planetary gear set (P2), and the third element (E32) of the second planetary gear set (P2) is connected to a rotationally fixed component of the transmission (G) for conjoint rotation.

19. The transmission (G) of claim 17, wherein the first element (E12) of the second planetary gear set (P2) is connected to the second element (E21) of the first planetary gear set (P1) for conjoint rotation in order to conduct the drive power of the electric machine (EM) into the second planetary gear set (P2), the second element (E22) of the second planetary gear set (P2) is configured to conduct the drive power of the electric machine (EM) out of the second planetary gear set (P2), and the third element (E32) of the second planetary gear set (P2) is connected to a rotationally fixed component of the transmission (G) for conjoint rotation.

20. The transmission (G) of claim 16, wherein the differential (D) is a spur gear differential (P3), the spur gear differential (P3) comprising a first element (E13), a second element (E23) and a third element (E33).

21. The transmission (G) of claim 20, wherein the first element (E13) of the spur gear differential (P3) is connected to the first output shaft (AB1) for conjoint rotation, the second element (E23) of the spur gear differential (P3) is configured to conduct a drive power from the electric machine (EM) into the spur gear differential (P3), and the third element (E33) of the spur gear differential (P3) is connected to the second output shaft (AB2) for conjoint rotation.

22. The transmission (G) of claim 16, wherein the differential (D) is a ball differential and comprises a differential cage (DK) and a plurality of differential bevel gears (AR1, AR2).

23. The transmission (G) of claim 16, further comprising a second planetary gear set (P2) arranged in power flow between the first planetary gear set (P1) and the differential (D), wherein the first and the second planetary gear sets (P1, P2) are arranged axially in series.

24. The transmission (G) of claim 16, further comprising a second planetary gear set (P2) arranged in power flow between the first planetary gear set (P1) and the differential (D), wherein the first and the second planetary gear sets (P1, P2) are radially stacked.

25. The transmission (G) of claim 16, further comprising a front-mounted planetary gear set (P4) arranged in power flow upstream of the first planetary gear set (P1), wherein the front-mounted planetary gear set (P4) comprises a first element (E14), a second element (E24) and a third element (E34).

26. The transmission (G) of claim 25, wherein the first element (E14) of the front-mounted planetary gear set (P4) is connected to a rotationally fixed component of the transmission (G) for conjoint rotation via a first shift element (B), two of the three elements (E14, E24, E34) of the front-mounted planetary gear set (P4) are connectable to each other for conjoint rotation via a second shift element (K) in order to interlock the front-mounted planetary gear set (P4).

27. The transmission (G) of claim 26, wherein:
the first element (E14) of the front-mounted planetary gear set (P4) is connectable to the third element (E34) of the front-mounted planetary gear set (P4) for conjoint rotation via the second shift element (K);
the second element (E24) of the front-mounted planetary gear set (P4) is connectable to the first element (E14) of the front-mounted planetary gear set (P4) for conjoint rotation via the second shift element (K); or
the third element (E34) of the front-mounted planetary gear set (P4) is connectable to the second element (E24) of the front-mounted planetary gear set (P4) for conjoint rotation via the second shift element (K).

28. The transmission (G) of claim 26, wherein:
the first and the second shift elements (B, K) are configured to implement a first gear step and a second gear step;
when the first shift element (B) is engaged and the second shift element (K) is disengaged, the first gear step is implemented; and
when the first shift element (B) is disengaged and the second shift element (K) is engaged, the second gear step is implemented.

29. The transmission (G) of claim 26, wherein at least the front-mounted planetary gear set (P4), the first and second shift elements (B, K), the first planetary gear set (P1), and the differential (D) are arranged in a common housing (GG), wherein the electric machine (EM) is arrangeable at least axially between the front-mounted planetary gear set (P4) and the first planetary gear set (P1) within the common housing (GG).

30. An electric propulsion system for a motor vehicle, comprising the transmission (G) of claim 16 and the electric machine (EM).
